(19) United States
(12) Patent Application Publication
(10) Pub. No.: US 2013/0122873 A1
(43) Pub. Date: May 16, 2013

(54) Method and system for realizing call priority access

(71) Applicants: Duancheng Song, Shenzhen (CN); Minggui Yang, Shenzhen (CN); Benrong Xiao, Shenzhen (CN)

(72) Inventors: Duancheng Song, Shenzhen (CN); Minggui Yang, Shenzhen (CN); Benrong Xiao, Shenzhen (CN)

(73) Assignee: ZTE CORPORATION, Shenzhen, Guangdong (CN)

(21) Appl. No.: 13/811,386

(22) PCT Filed: Oct. 22, 2010
(86) PCT No.: PCT/CN2010/078028

§ 371 Date: Jan. 22, 2013

(30) Foreign Application Priority Data
Jul. 23, 2010 (CN) 201010236092.5

(51) Int. Cl. H04W 72/10

(52) U.S. Cl. CPC H04W 72/10
USPC 455/414.1

(57) ABSTRACT

The disclosure provides a method for realizing call priority access, which includes: a Mobile Switching Center emulation (MSCe) adds priority information of a current call into a message of establishing a terminal which is notified to a Media Gateway (MGW); the MGW obtains priority of the call; and the MGW applies for call-related resources for the current call, and performs call priority access processing according to the priority of the current call when the call-related resources applied for by the MGW are busy. The disclosure further provides a system for realizing call priority access. The solution of the disclosure enables the MGW to realize the call priority access in a priority access way when the MGW applies for call-related resources, enriches and improves call priority access service of a communication network, and has extensive application prospect.

### TECHNICAL FIELD

The disclosure relates to a call access technology in communication systems, and particularly to a method and system for realizing call priority access.

### BACKGROUND

Since a call priority access service can assure that some specific subscribers can preferentially utilize resources of communication networks to make a call, applications of the call priority access service are very important, wherein the specific subscribers are, for example, higher level subscribers of military networks, or government staff, relief workers and the like being responsible for coordinate and deal with an emergency situation (such as earthquake, typhoon and other natural disasters) when a country is in the emergency situation.

At present, a known call priority access service includes: Priority Access and Channel Assignment (PACA), MultiLevel Precedence and Preemption (MLPP), Wireless is Priority Service (WPS), American Government Emergency Telecommunication Service (GETS) and other services.

These services and protocols thereof mainly describes priority access conditions of resources such as Circuit Identification Code (CIC) resources required for call connection, air interface resources (wireless network) and the like.

For the CIC resources, the call priority access is generally realized in two ways:

1) forced way (ForcedWay): when a priority access call occupies CIC resources, if no another idle CIC resources, then the CIC resources for a low priority call are released and are allocated to the current call to use; and

2) queue way (QueueWay): when a priority access call occupies CIC resources, if no another idle CIC resources, then the current call is added to a queue according to the priority of the current call, once there are idle CIC resources, the idle CIC resources are preferentially used by one call which is located at the head of the queue.

In the above call priority access services, a core network mainly processes calls based on the CIC resources; as long as the CIC resources are occupied, the calls can be connected. However, nowadays core networks are Internet Protocol (IP)-based, a call may probably never use CIC resources; if the call is connected successfully, then the call must occupy call-related resources such as Real-time Transport Protocol (RTP) resources on a Media Gateway (MGW), Transmission Coder (TC) resources, Inter Working Function (IWF) resources, resources used by T.38 fax and other resources. Without these resources above, the call cannot be established; therefore, when an MGW applies for these resources, if these resources are busy, then the call priority access also needs to be realized according to the above two ways, in order to completely realize the call priority access service. However, the current H.248 protocol does not support to transfer information of the call priority access service to an MGW, so when it needs to apply for these resources on the MGW, the call priority access service cannot be realized.

### SUMMARY

In view of the problem above, the main purpose of the disclosure is to provide a method and system for realizing call priority access, which enable an MGW to realize a call priority access service in a priority access way when the MGW applies for call-related resources, enriching and improving the call priority access service.

In order to achieve the purpose above, the technical solution of the disclosure is realized as follows.

A method for realizing call priority access is provided, which includes:

adding, by a Mobile Switching Center emulation (MSCe), priority information of a current call into a message of establishing a terminal which is notified to a Media Gateway (MGW); obtaining, by the MGW, priority of the current call; and

applying for, by the MGW, call-related resources for the current call, and performing call priority access processing according to the priority of the current call when the call-related resources applied for by the MGW are busy.

In the above solution, a call priority access way is pre-configured to a forced way; when the call-related resources applied for by the MGW are busy, the performing call priority access processing according to the priority of the current call may include: forcibly releasing corresponding call-related resources for one call of which priority is lower than the priority of the current call, and notifying an MSCe of the call where the corresponding call-related resources are located to release the call; using, by the MGW, the call-related resources for the call released for the current call, and recording priority of the corresponding call-related resources as the priority of the current call; and then, notifying the MSCe of establishing a terminal successfully.

In the above solution, a call priority access way is pre-configured to a queue way; when the call-related resources applied for by the MGW are busy, the performing call priority access processing according to the priority of the current call may include: adding the current call into a corresponding call-related resource queue to queue according to the priority of the current call and start time of the current call, and starting a protection timer; when the MGW detects that there are idle call-related resources, preferentially providing the idle call-related resources to one call located at a head of the corresponding call-related resource queue to use, and notifying a corresponding MSCe of successfully establishing a terminal.

In the above solution, the adding priority information of a current call may include: adding a call priority access package into the message of establishing a terminal which is notified to the MGW; wherein the call priority access package includes a PriorityAccessLevel property for setting the priority of the current call.

In the above solution, the call priority access package may further include a PriorityMethod property for designating a call priority access way, wherein the call priority access way includes a forced way and a queue way; and

performing, by the MGW, the call priority access processing according to the call priority access way designated by the PriorityMethod property in the call priority access package.

In the above solution, the call priority access package may further include a Priority Access Result (PARes) event for reporting a result of the current priority access call when the MGW detects that the call-related resources applied for by the MGW are busy and adds the current call into a corresponding call-related resource queue to queue in the queue way; and

the call priority access package received by the MGW includes the PARes event, after the MGW adds the current call into the corresponding call-related resource queue to queue according to the priority of the current call and start time of the current call in the call priority access package, notifying, by the MGW, the MSCe of resource queue occurrence in the PARes event by a notification (Notify) message; after receiving the Notify message, recording, by the MSCe, a Termination Identifier (TerminationID) included in the Notify message, resetting a timer and notifying a related network element.

A system for realizing call priority access includes: a Mobile Switching Center emulation (MSCe) and a Media Gateway (MGW), wherein

the MSCe is configured to add priority information of a current call into a message of establishing a terminal which is notified to the MGW; and

the MGW is configured to receive the message of establishing a terminal from the MSCe, and obtain priority of the current call from the message of establishing a terminal; and to apply for call-related resources for the current call, and perform call priority access processing according to the priority of the current call when the call-related resources applied for by the MGW are busy.

In the above solution, the MGW may include: a message receiving module and a call priority access module; wherein

the message receiving module is configured to receive the message of establishing a terminal from the MSCe, obtain the priority of the current call from the message of establishing a terminal, and send the priority of the current call to the call priority access module; and

the call priority access module is configured to apply for the call-related resources for the current call, and perform the call priority access processing according to the priority of the current call when the call-related resources applied for the call priority access module are busy.

In the above solution, the MSCe may be configured to add a call priority access package into the message of establishing a terminal which is notified to the MGW, wherein the call priority access package includes a PriorityAccessLevel property for setting the priority of the current call.

In the above solution, the call priority access module may be further configured to perform the call priority access processing according to a call priority access way designated by a PriorityMethod property when the call priority access package includes the PriorityMethod property.

In the above solution, when the call priority access package includes a Priority Access Result (PARes) event, the call priority access module may be further configured to notify the MSCe of resource queue occurrence in the PARes event by a Notify message after adding the current call into a corresponding call-related resource queue to queue according to the priority of the current call and start time of the current call;

correspondingly, the MSCe may be further configured to, after receiving the Notify message, record a Termination Identifier (TerminationID) included in the Notify message, reset a timer and notify a related network element.

In the method and system for realizing call priority access, an MSCe adds priority of a call into a message of establishing a terminal which is notified to an MGW; the MGW obtains the priority of the current call; and the MGW applies for call-related resources for the current call, and performs call priority access processing according to the priority of the current call when the call-related resources applied for by the MGW are busy; in this way, the MGW can realize the call priority access in a priority access way when applying for call-related resources, so that call priority access service of a communication network is enriched and improved, and application prospect is extensive.

### BRIEF DESCRIPTION OF THE DRAWINGS

FIG. 1 shows a flowchart of a method for realizing call priority access according to the disclosure;

FIG. 2 shows a structural diagram of a system for realizing call priority access according to the disclosure; and

FIG. 3 shows a flowchart of a method for realizing call priority access according to the disclosure, taking, for example, RTP resources as call-related resources.

### DETAILED DESCRIPTION

The basic concept of the disclosure is that: an MSCe adds priority information of a current call into a message of establishing a terminal which is notified to an MGW; the MGW obtains priority of the current call; and the MGW applies for call-related resources for the current call, and performs call priority access processing according to the priority of the current call when the call-related resources applied for by the MGW are busy.

The disclosure will be further described in detail in combination with the drawings and specific embodiments hereinafter.

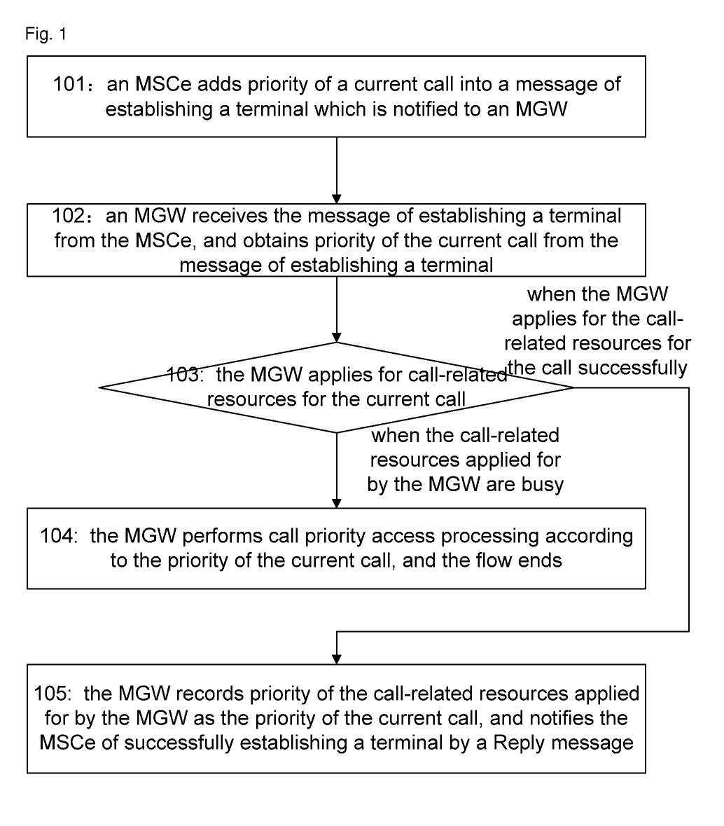

A method for realizing call priority access according to the disclosure, as shown in FIG. 1, includes the following steps:

Step 101: an MSCe adds priority of a current call into a message of establishing a terminal which is notified to an MGW.

In this step, the adding priority of a current call may be: adding a call priority access package into the message of establishing a terminal which is notified to the MGW, wherein the call priority access package includes a PriorityAccessLevel property for setting the priority of the current call; further, the call priority access package may further include a PriorityMethod property for designating a call priority access way, wherein the call priority access way includes a forced way (ForcedWay), a queue way (QueueWay) and the like; further, the call priority access package may further include a PARes event for reporting a result of the priority access call when the MGW detects that the call-related resources applied for by the MGW are busy and adds the current call into a corresponding call-related resource queue to queue in the queue way;

the call priority access package may be defined as follows:

```
    Properties:
        Priority Access Level:
            PropertyID: PriorityAccessLevel(0x0001);
            Description: defining the priority of call priority access,
the smaller a numerical value is, the higher the priority is;
            Type: Integer;
            Possible values: 0~15;
                Defined in: Local Control Descriptor;
            Characteristics: Read/Write;
        Priority Method:
            PropertyID: PriorityMethod (0x0002);
            Description: indicating a call priority access way used by
            the MGW;
            Type: Enumeration;
            Possible values:
                “ForcedWay” (0x0001): Forced Way;
                “QueueWay” (0x0002): Queue Way;
              Defined in: Local Control Descriptor;
            Characteristics: Read/Write;
    Events:
        EventID: PARes (0x0001);
        Description: reporting a result of the call priority access;
        EventsDescriptor Parameters: None;
        ObservedEventsDescriptor Parameters:
            ParameterId: result (0x0001);
            Description: reporting a result of the call priority access;
            Type: Enumeration;
            Possible Values:
                “PAQueueWay”(0x0001): a priority access call of a
QueueWay occurs on an MGW.
    Signals: None;
    Statistics: None;
    Procedures: None.
```

The priority of the current call can be obtained according to a method for obtaining priority in an existing call priority access protocol, for example, in a PACA protocol, the is priority of a call is obtained by a subscription property of a subscriber;

the message of establishing a terminal which is notified to the MGW is generally an Add message;

the call-related resources include RTP resources, TC resources, IWF resources, resources used by a T.38 fax and other resources.

Step 102: an MGW receives the message of establishing a terminal from the MSCe, and obtains priority of the current call from the message of establishing a terminal.

Step 103: the MGW applies for call-related resources for the current call, and step 104 is executed when the call-related resources applied for by the MGW are busy; step 105 is executed when the MGW applies for the call-related resources for the call successfully.

Step 104: the MGW performs call priority access processing according to the priority of the current call, and the flow ends.

For example, if the call priority access way is pre-configured to the forced way, when the call-related resources applied for by the MGW are busy, then corresponding call-related resources for one call, of which the priority is lower than the priority of the current call, are forcibly released, and an MSCe of the call where the corresponding call-related resources are located is notified to release the call, and the notified MSCe releases the call; the MGW uses the corresponding call-related resources for the call released for the current call, and records the priority of the corresponding call-related resources as the priority of the current call; and then, notifies the MSCe of successfully establishing a terminal by a replay message (Reply).

Further, if the MGW does not find corresponding call-related resources of which the priority is lower than the priority of the current call, then the MGW notifies the MSCe of unsuccessfully establishing a terminal by a Reply message.

As another example, if the call priority access way is pre-configured to the queue way, when the call-related resources applied for by the MGW are busy, then the current call is added into a corresponding call-related resource queue to queue according to the priority of the current call and start time of the current call, and a protection timer Timer_QueueWay is started to prevent the MGW from waiting in the queue all the time; when the MGW detects that there are idle call-related resources, the idle call-related resources are preferentially provided to one call located at a head of the corresponding call-related resource queue to use, and the MSCe corresponding to the call which uses the idle call-related resources is notified of successfully establishing a terminal by a Reply message.

Further, when the protection timer Timer_QueueWay is overtime, the MGW notifies the MSCe corresponding to the call of unsuccessfully establishing a terminal by a Reply message.

Further, the MGW receives a call priority access package, when the call priority access package includes a PARes event, after the MGW adds the current call into the corresponding call-related resource queue to queue according to the priority of the current call and the start time of the current call in the call priority access package, the MGW notifies the MSCe of resource queue occurrence in the PARes event by a Notify message, that is, the Notify message includes the call priority access package and a TerminationID, in which PARes equals to PAQueueWay; after receiving the Notify message, the MSCe records the TerminationID, and performs operations such as resetting a timer, notifying other related network elements and the like, here, the resetting a timer refers to resetting a timer started by the MSCe when sending the message of establishing a terminal which is notified to the MGW.

The step further includes the following steps: the MGW receives the call priority access package, and performs the call priority access processing according to a call priority access way designated by the PriorityMethod property in the call priority access package; when the call priority access way is designated as the forced way, the method of performing the call priority access processing by the MGW is the same as the method used when the call priority access way pre-configured above is the forced way; when the call priority access way is designated as the queue way, the method of performing the call priority access processing by the MGW is the same as the method used when the call priority access way pre-configured above is the queue way;

the call priority access way pre-configured above is generally a call priority access way which is pre-configured on a background of the MGW;

when the call priority access way is the queue way, the step further includes the following step: the MSCe notifies the MGW of releasing a terminal and a corresponding call in a call priority queue by a Subtract message, when the timer, which is started by the MSCe when sending the message of establishing a terminal which is notified to the MGW, is overtime, or when the MSCe receives a message released by other network elements.

Step 105: the MGW records priority of the call-related resources applied for by the MGW as the priority of the current call, and notifies the MSCe of successfully establishing a terminal by a Reply message.

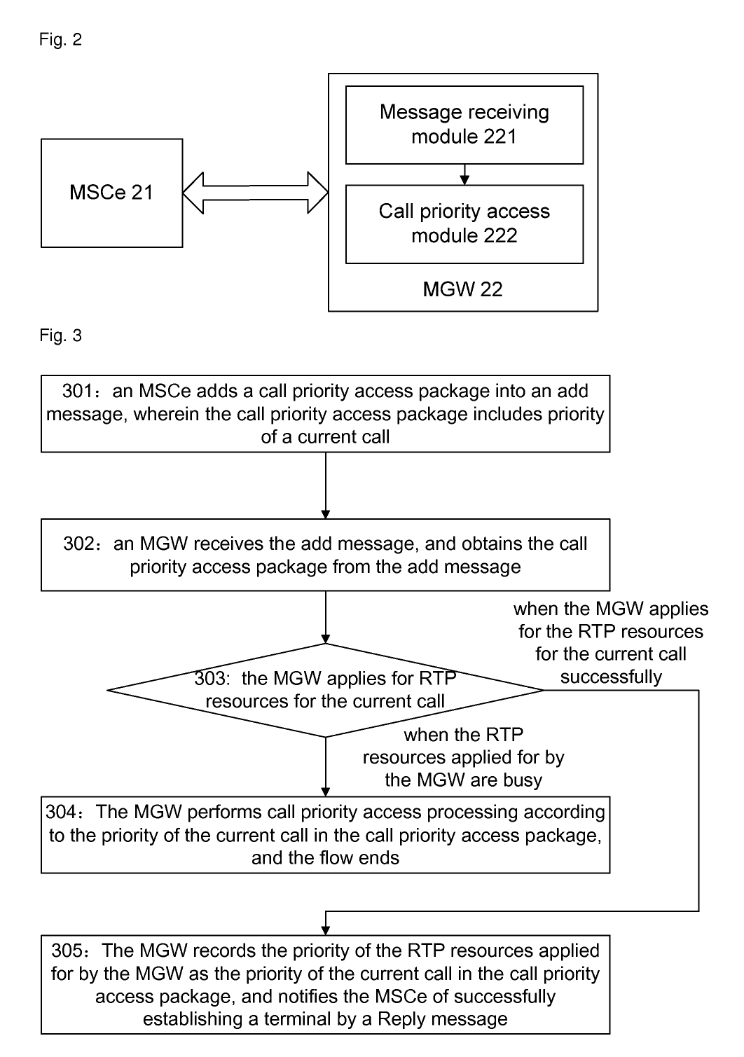

In order to achieve the above method, the disclosure provides a system for realizing call priority access, as shown in FIG. 2, and the system includes: an MSCe 21 and an MGW 22;

the MSCe 21 is configured to add priority of a current call into a message of establishing a terminal which is notified to the MGW 22; and

the MGW 22 is configured to receive the message of establishing a terminal from the MSCe 21, and obtain the priority of the current call from the message of establishing a terminal; and to apply for call-related resources for the current call, and perform call priority access processing according to the priority of the current call when the call-related resources applied for by the MGW are busy.

The MSCe 21 adds the priority of a current call into a message of establishing a terminal which is notified to the MGW 22, generally, the MSCe 21 adds a call priority access package into the message of establishing a terminal which is notified to the MGW 22; wherein the call priority access package includes a PriorityAccessLevel property for setting the priority of the current call; further, the call priority access package may include a PriorityMethod property for designating a call priority access way, wherein the call priority access way includes a forced way, a queue way and the like; further, the call priority access package may further include a PARes event for reporting a result of the priority access call when the MGW 22 detects that the call-related resources applied for by the MGW 22 are busy and adds the current call into a corresponding call-related resource queue to queue in a queue way.

The MGW 22 includes: a message receiving module 221 and a call priority access module 222;

the message receiving module 221 is configured to receive the message of establishing a terminal from the MSCe 21, obtain the priority of the current call from the message of establishing a terminal, and send the priority of the current call to the call priority access module 222; and

the call priority access module 222 is configured to apply for the call-related resources for the current call, and perform the call priority access processing according to the priority of the current call when the call-related resources applied for by the call priority access module 222 are busy.

For example, if the call priority access way is pre-configured to the forced way, when the call-related resources applied for by the call priority access module 222 are busy, then the call priority access module 222 forcibly releases corresponding call-related resources for one call of which the priority is lower than the priority of the current call, and notifies the MSCe 21 of the call where the corresponding call-related resources are located to release the call; after the MSCe 21 release the call, the call priority access module 222 uses the corresponding call-related resources for the call released for the current call, and records the priority of the corresponding call-related resources as the priority of the current call; and then, notifies the MSCe 21 of successfully establishing a terminal by a Reply message;

further, if the call priority access module 222 does not find corresponding call-related resources of which the priority is lower than the priority of the current call, then the MGW notifies the MSCe 21 of unsuccessfully establishing a terminal by a Reply message.

As another example, if the call priority access way is pre-configured to the queue way, when the call-related resources applied for by the call priority access module 222 are busy, then the call priority access module 222 adds the current call into a corresponding call-related resource queue to queue according to the priority of the current call and start time of the current call, and starts a protection timer Timer_QueueWay; when detecting that there are corresponding idle call-related resources, the call priority access module 222 preferentially provides the corresponding idle call-related resources to one call located at a head of the corresponding call-related resource queue to use, and notifies the MSCe 21 corresponding to the call which uses the corresponding idle call-related resources of successfully establishing a terminal by a Reply message.

Further, when the Timer_QueueWay is overtime, the call priority access module 222 notifies the MSCe 21 corresponding to the call of unsuccessfully establishing a terminal by a Reply message.

Further, after the call priority access module 222 adds the current call into the corresponding call-related resource queue to queue according to the priority of the current call and the start time of the current call in the call priority access package, when the call priority access package includes a PARes event, the call priority access module 222 notifies the MSCe 21 of resource queue occurrence in the PARes event by a Notify message, that is, the Notify message includes the call priority access package and a TerminationID, in which PARes equals to PAQueueWay;

correspondingly, the MSCe 21 is further configured to, after receiving the Notify message, record the TerminationID, and performs operations such as resetting a timer, notifying other related network elements and the like, here, the resetting a timer refers to resetting a timer started by the MSCe 21 when sending the message of establishing a terminal which is notified to the MGW 22.

Further, the call priority access module 222 is further configured to perform the call priority access processing according to a call priority access way designated by the PriorityMethod property when the call priority access package includes the PriorityMethod property;

further, the MSCe 21 is further configured to notify the MGW 22 of releasing a terminal and a corresponding call in a call priority queue by a Subtract message, when the timer, which is started by the MSCe 21 when sending the message of establishing a terminal notified, is overtime, or when the MSCe 21 receives a message released by other network elements;

correspondingly, the message receiving module 221 is further configured to notify the call priority access module 222 after receiving the Subtract message; and the call priority access module 222 releases the corresponding terminal and the corresponding call in the call priority queue;

further, the call priority access module 222 is further configured to record the priority of the call-related resources applied for by the call priority access module 222 as the priority of the current call, and notifies the MSCe 21 of successfully establishing a terminal by a Reply message.

Implementing process and principle of the method of the disclosure will be illustrated in detail in combination with one specific embodiment hereinafter.

Taking, for example, RTP resources as call-related resources, a method for realizing call priority access according to the disclosure, as shown in FIG. 3, includes the following several steps.

Step 301: an MSCe adds a call priority access package into an add (Add) message, wherein the call priority access package includes priority of a current call.

In the step, the call priority access package may include a PriorityAccessLevel property for setting the priority of the current call; further, the call priority access package may further include a PriorityMethod property for designating a call priority access way, wherein the call priority access way includes a forced way, a queue way and the like; further, the call priority access package may further include a PARes event for reporting a result of the priority access call when an MGW detects that the call-related resources applied for by the MGW are busy and adds the current call into a corresponding call-related resource queue to queue in a queue way;

the priority of the current call can be obtained according to a method for obtaining priority in an existing call priority access protocol, for example, in a PACA protocol, the priority of a call is obtained by a subscription property of a subscriber.

Step 302: an MGW receives the Add message, and obtains the call priority access package from the Add message.

Step 303: the MGW applies for RTP resources for the current call, step 104 is executed when the RTP resources applied for by the MGW are busy; and step 105 is executed when the MGW applies for the RTP resources for the current call successfully.

Step 304: the MGW performs call priority access processing according to the priority of the current call in the call priority access package, and the flow ends.

For example, if the call priority access way is pre-configured to the forced way, when the RTP resources applied for by the MGW are busy, then corresponding RTP resources for one call, of which the priority is lower than the priority of the current call in the call priority access package, are forcibly released, and an MSCe of the call where the corresponding RTP resources are located is notified to release the call, and the MSCe releases the call branch after receiving the notification, wherein the notification is generally a G package CAUSE event in the existing Add message reported by a Notify message; the MGW uses the corresponding RTP resources for the call released for the current call, and records the priority of the corresponding RTP resources as the priority of the current call in the call priority access package; and then, notifies the MSCe of successfully establishing a terminal by a Reply message;

further, if the MGW does not find corresponding RTP resources of which the priority is lower than the priority of the current call in the call priority access package, then the MGW notifies the MSCe of unsuccessfully establishing a terminal by a Reply message.

As another example, if the call priority access way is pre-configured to the queue way, when the RTP resources applied for by the MGW are busy, then the current call is added into a corresponding RTP resource queue to queue according to the priority of the current call and start time of the current call in the call priority access package, and a protection timer Timer_QueueWay is started to prevent the MGW from waiting in the queue all the time; when the MGW detects that there are idle RTP resources, the idle RTP resources are preferentially provided to one call located at a head of the corresponding RTP resource queue to use, and the MSCe corresponding to the call which uses the idle RTP resources is notified of successfully establishing a terminal by a Reply message.

Further, when the protection timer Timer_QueueWay is overtime, the MGW notifies the MSCe corresponding to the call of unsuccessfully establishing a terminal by a Reply message.

Further, the call priority access package received by the MGW includes a PARes event, after the MGW adds the current call into the corresponding RTP resource queue to queue according to the priority of the current call and the start time of the current call in the call priority access package, the MGW notifies the MSCe of resource queue occurrence in the PARes event by a Notify message, that is, the Notify message includes the call priority access package and a termination identifier (TerminationID), in which PARes equals to PAQueueWay; after receiving the Notify message, the MSCe records the TerminationID, and performs operations such as resetting a timer, notifying other related network elements and the like, here, the resetting a timer refers to resetting a timer started by the MSCe when sending the message of establishing a terminal which is notified to the MGW.

The step further includes the following steps: the MGW performs the call priority access processing according to a call priority access way designated by the PriorityMethod property in the call priority access package;

the call priority access way pre-configured above is generally a call priority access way which is pre-configured on a background of the MGW;

when the call priority access way is the queue way, the step further includes the following step: the MSCe notifies the MGW of releasing a terminal and a corresponding call in a call priority queue by a Subtract message, when the timer, which is started by the MSCe when sending the message of establishing a terminal which is notified to the MGW, is overtime, or when the MSCe receives a message released by other network elements.

Step 305: the MGW records the priority of the RTP resources applied for by the MGW as the priority of the current call in the call priority access package, and notifies the MSCe of successfully establishing a terminal by a Reply message.

By means of the above method, the call priority access can be realized in a priority access way when the MGW applies for call-related resources, and call priority access service of a communication network is enriched and improved; nowadays communication networks are completely IP-based, an idea of separating carrying from control has been applied to Code Division Multiple Access 2000 (CDMA2000), Wideband Code Division Multiple Access (WCDMA), Time Division-Synchronization Code Division Multiple Access (TD-SCDMA), Next Generation Network (NGN), IP Multimedia Subsystem (IMS) and other communication networks, and the disclosure can be applied to realize call priority access service in these networks and have extensive application prospect.

The above are only preferable embodiments of the disclosure, and are not used for limiting to the scope of protection of the disclosure. Any modifications, equivalent substitutes, improvements or the like made within the concept and principle of the disclosure shall fall within the scope of protection of the disclosure.

What is claimed is:

1. A method for realizing call priority access, comprising:
adding, by a Mobile Switching Center emulation (MSCe), priority information of a current call into a message of establishing a terminal which is notified to a Media Gateway (MGW); obtaining, by the MGW, priority of the current call; and
applying for, by the MGW, call-related resources for the current call, and performing call priority access processing according to the priority of the current call when the call-related resources applied for by the MGW are busy.

2. The method according to claim 1, wherein a call priority access way is pre-configured to a forced way; when the call-related resources applied for by the MGW are busy, the performing call priority access processing according to the priority of the current call comprises: forcibly releasing corresponding call-related resources for one call of which priority is lower than the priority of the current call, and notifying an MSCe of the call where the corresponding call-related resources are located to release the call; using, by the MGW, the call-related resources for the call released for the current call, and recording priority of the corresponding call-related resources as the priority of the current call; and then, notifying the MSCe of establishing a terminal successfully.

3. The method according to claim 1, wherein a call priority access way is pre-configured to a queue way; when the call-related resources applied for by the MGW are busy, the performing call priority access processing according to the priority of the current call comprises: adding the current call into a corresponding call-related resource queue to queue according to the priority of the current call and start time of the current call, and starting a protection timer; when the MGW detects that there are idle call-related resources, preferentially providing the idle call-related resources to one call located at a head of the corresponding call-related resource queue to use, and notifying a corresponding MSCe of successfully establishing a terminal.

4. The method according to claim 1, wherein the adding priority information of a current call comprises: adding a call priority access package into the message of establishing a terminal which is notified to the MGW; wherein the call priority access package comprises a PriorityAccessLevel property for setting the priority of the current call.

5. The method according to claim 4, wherein the call priority access package further comprises a PriorityMethod property for designating a call priority access way, wherein the call priority access way comprises a forced way and a queue way; and
performing, by the MGW, the call priority access processing according to the call priority access way designated by the PriorityMethod property in the call priority access package.

6. The method according to claim 4, wherein the call priority access package further comprises a Priority Access Result (PARes) event for reporting a result of the current priority access call when the MGW detects that the call-related resources applied for by the MGW are busy and adds the current call into a corresponding call-related resource queue to queue in the queue way; and
the call priority access package received by the MGW comprises the PARes event, after the MGW adds the current call into the corresponding call-related resource queue to queue according to the priority of the current call and start time of the current call in the call priority access package, notifying, by the MGW, the MSCe of resource queue occurrence in the PARes event by a notification (Notify) message; after receiving the Notify message, recording, by the MSCe, a Termination Identifier (TerminationID) included in the Notify message, resetting a timer and notifying a related network element.

7. A system for realizing call priority access, comprising: a Mobile Switching Center emulation (MSCe) and a Media Gateway (MGW), wherein
the MSCe is configured to add priority information of a current call into a message of establishing a terminal which is notified to the MGW; and
the MGW is configured to receive the message of establishing a terminal from the MSCe, and obtain priority of the current call from the message of establishing a terminal; and to apply for call-related resources for the current call, and perform call priority access processing according to the priority of the current call when the call-related resources applied for by the MGW are busy.

8. The system according to claim 7, wherein the MGW comprises: a message receiving module and a call priority access module; wherein
the message receiving module is configured to receive the message of establishing a terminal from the MSCe, obtain the priority of the current call from the message of establishing a terminal, and send the priority of the current call to the call priority access module; and
the call priority access module is configured to apply for the call-related resources for the current call, and perform the call priority access processing according to the priority of the current call when the call-related resources applied for the call priority access module are busy.

9. The system according to claim 7, wherein the MSCe is configured to add a call priority access package into the message of establishing a terminal which is notified to the MGW, wherein the call priority access package comprises a PriorityAccessLevel property for setting the priority of the current call.

10. The system according to claim 9, wherein the call priority access module is further configured to perform the call priority access processing according to a call priority access way designated by a PriorityMethod property when the call priority access package comprises the PriorityMethod property.

11. The system according to claim 9, wherein when the call priority access package comprises a Priority Access Result (PARes) event, the call priority access module is further configured to notify the MSCe of resource queue occurrence in the PARes event by a Notify message after adding the current call into a corresponding call-related resource queue to queue according to the priority of the current call and start time of the current call;
correspondingly, the MSCe is further configured to, after receiving the Notify message, record a Termination Identifier (TerminationID) included in the Notify message, reset a timer and notify a related network element.

12. The method according to claim 2, wherein the adding priority information of a current call comprises: adding a call priority access package into the message of establishing a terminal which is notified to the MGW; wherein the call priority access package comprises a PriorityAccessLevel property for setting the priority of the current call.

13. The method according to claim 3, wherein the adding priority information of a current call comprises: adding a call priority access package into the message of establishing a terminal which is notified to the MGW; wherein the call priority access package comprises a PriorityAccessLevel property for setting the priority of the current call.

14. The method according to claim 12, wherein the call priority access package further comprises a PriorityMethod property for designating a call priority access way, wherein the call priority access way comprises a forced way and a queue way; and
performing, by the MGW, the call priority access processing according to the call priority access way designated by the PriorityMethod property in the call priority access package.

15. The method according to claim 13, wherein the call priority access package further comprises a PriorityMethod property for designating a call priority access way, wherein the call priority access way comprises a forced way and a queue way; and
performing, by the MGW, the call priority access processing according to the call priority access way designated by the PriorityMethod property in the call priority access package.

16. The method according to claim 12, wherein the call priority access package further comprises a Priority Access Result (PARes) event for reporting a result of the current priority access call when the MGW detects that the call-related resources applied for by the MGW are busy and adds the current call into a corresponding call-related resource queue to queue in the queue way; and
the call priority access package received by the MGW comprises the PARes event, after the MGW adds the current call into the corresponding call-related resource queue to queue according to the priority of the current call and start time of the current call in the call priority access package, notifying, by the MGW, the MSCe of resource queue occurrence in the PARes event by a notification (Notify) message; after receiving the Notify message, recording, by the MSCe, a Termination Identifier (TerminationID) included in the Notify message, resetting a timer and notifying a related network element.

17. The method according to claim 13, wherein the call priority access package further comprises a Priority Access Result (PARes) event for reporting a result of the current priority access call when the MGW detects that the call-related resources applied for by the MGW are busy and adds the current call into a corresponding call-related resource queue to queue in the queue way; and
the call priority access package received by the MGW comprises the PARes event, after the MGW adds the current call into the corresponding call-related resource queue to queue according to the priority of the current call and start time of the current call in the call priority access package, notifying, by the MGW, the MSCe of resource queue occurrence in the PARes event by a notification (Notify) message; after receiving the Notify message, recording, by the MSCe, a Termination Identifier (TerminationID) included in the Notify message, resetting a timer and notifying a related network element.

18. The system according to claim 8, wherein the MSCe is configured to add a call priority access package into the message of establishing a terminal which is notified to the MGW, wherein the call priority access package comprises a PriorityAccessLevel property for setting the priority of the current call.

19. The system according to claim 18, wherein the call priority access module is further configured to perform the call priority access processing according to a call priority access way designated by a PriorityMethod property when the call priority access package comprises the PriorityMethod property.

20. The system according to claim 10, wherein when the call priority access package comprises a Priority Access Result (PARes) event, the call priority access module is further configured to notify the MSCe of resource queue occurrence in the PARes event by a Notify message after adding the current call into a corresponding call-related resource queue to queue according to the priority of the current call and start time of the current call;
correspondingly, the MSCe is further configured to, after receiving the Notify message, record a Termination Identifier (TerminationID) included in the Notify message, reset a timer and notify a related network element.

21. The system according to claim 18, wherein when the call priority access package comprises a Priority Access Result (PARes) event, the call priority access module is further configured to notify the MSCe of resource queue occurrence in the PARes event by a Notify message after adding the current call into a corresponding call-related resource queue to queue according to the priority of the current call and start time of the current call;
correspondingly, the MSCe is further configured to, after receiving the Notify message, record a Termination Identifier (TerminationID) included in the Notify message, reset a timer and notify a related network element.

22. The system according to claim 19, wherein when the call priority access package comprises a Priority Access Result (PARes) event, the call priority access module is further configured to notify the MSCe of resource queue occurrence in the PARes event by a Notify message after adding the current call into a corresponding call-related resource queue to queue according to the priority of the current call and start time of the current call;
correspondingly, the MSCe is further configured to, after receiving the Notify message, record a Termination Identifier (TerminationID) included in the Notify message, reset a timer and notify a related network element.
